(19) United States
(12) Patent Application Publication
(10) Pub. No.: US 2025/0133626 A1
(43) Pub. Date: Apr. 24, 2025

(54) CELL MEASUREMENT WITH A LOW-POWER WAKEUP RADIO

(71) Applicant: QUALCOMM Incorporated, San Diego, CA (US)

(72) Inventors: Prashant SHARMA, San Marcos, CA (US); Changhwan PARK, San Diego, CA (US); Linhai HE, San Diego, CA (US)

(21) Appl. No.: 18/493,693

(22) Filed: Oct. 24, 2023

(51) Int. Cl. H04W 76/28; H04W 36/00

(52) U.S. Cl. CPC H04W 76/28; H04W 36/0085

(57) ABSTRACT

Various aspects of the present disclosure generally relate to wireless communication. In some aspects, a user equipment (UE) may receive a configuration of a discontinuous reception (DRX) cycle. The UE may perform one or more first cell measurements using a main radio of the UE and one or more second cell measurements using a low-power wakeup radio (LP-WUR) of the UE, wherein a quantity of the one or more first cell measurements and the one or more second cell measurements are in accordance with a parameter. The UE may evaluate a cell selection criterion according to at least one of the one or more first cell measurements or the one or more second cell measurements. The UE may transmit a communication in accordance with the one or more first cell measurements, the one or more second cell measurements, or the cell selection criterion. Numerous other aspects are described.

### FIELD OF THE DISCLOSURE

Aspects of the present disclosure generally relate to wireless communication and specifically relate to techniques, apparatuses, and methods for cell measurement with a low-power wakeup radio (LP-WUR).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving a configuration of a discontinuous reception (DRX) cycle; performing, in accordance with the DRX cycle, one or more first cell measurements using a main radio of the UE and one or more second cell measurements using a low-power wakeup radio (LP-WUR) of the UE, wherein a quantity of the one or more first cell measurements and a quantity of the one or more second cell measurements are in accordance with a parameter; evaluating a cell selection criterion according to at least one of the one or more first cell measurements or the one or more second cell measurements; and transmitting a communication in accordance with the one or more first cell measurements, the one or more second cell measurements, or the cell selection criterion.

In some aspects, an apparatus for wireless communication includes one or more memories comprising processor-executable instructions; and one or more processors configured to execute the processor-executable instructions and cause the apparatus to: receive a configuration of a DRX cycle; perform, in accordance with the DRX cycle, one or more first cell measurements using a main radio of the UE and one or more second cell measurements using a LP-WUR of the UE, wherein a quantity of the one or more first cell measurements and a quantity of the one or more second cell measurements are in accordance with a parameter; evaluate a cell selection criterion according to at least one of the one or more first cell measurements or the one or more second cell measurements; and transmit a communication in accordance with the one or more first cell measurements, the one or more second cell measurements, or the cell selection criterion.

In some aspects, a non-transitory computer-readable medium storing a set of instructions for wireless communication includes one or more instructions that, when executed by one or more processors of a UE, cause the UE to: receive a configuration of a DRX cycle; perform, in accordance with the DRX cycle, one or more first cell measurements using a main radio of the UE and one or more second cell measurements using a LP-WUR of the UE, wherein a quantity of the one or more first cell measurements and a quantity of the one or more second cell measurements are in accordance with a parameter; evaluate a cell selection criterion according to at least one of the one or more first cell measurements or the one or more second cell measurements; and transmit a communication in accordance with the one or more first cell measurements, the one or more second cell measurements, or the cell selection criterion.

In some aspects, an apparatus for wireless communication includes means for receiving a configuration of a DRX cycle; means for performing, in accordance with the DRX cycle, one or more first cell measurements using a main radio of the apparatus and one or more second cell measurements using a LP-WUR of the apparatus, wherein a quantity of the one or more first cell measurements and a quantity of the one or more second cell measurements are in accordance with a parameter; means for evaluating a cell selection criterion according to at least one of the one or more first cell measurements or the one or more second cell measurements; and means for transmitting a communication in accordance with the one or more first cell measurements, the one or more second cell measurements, or the cell selection criterion.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIGS. 4A, 4B, 4C, and 4D depict aspects of data structures for a wireless communications network in accordance with the present disclosure.

FIG. 5 is a diagram illustrating an example of a low-power wakeup radio or receiver (LP-WUR) and a low-power wakeup signal (LP-WUS), in accordance with the present disclosure.

FIG. 6 is a diagram illustrating an example of a discontinuous reception (DRX) configuration, in accordance with the present disclosure.

FIG. 7 is a diagram illustrating an example of radio resource monitoring (RRM) measurement, in accordance with the present disclosure.

FIG. 8 is a diagram illustrating an example of signaling for RRM measurement offloading, in accordance with the present disclosure.

FIG. 9 is a diagram illustrating examples of serving cell measurements and evaluation according to an offloading parameter, in accordance with the present disclosure.

FIG. 10 is a diagram illustrating examples of cell selection criterion evaluation, in accordance with the present disclosure.

FIG. 11 is a diagram illustrating examples of an adaptive RRM measurement offloading mechanism, in accordance with the present disclosure.

FIG. 12 is a diagram illustrating examples of a scaling factor for measurement relaxation, in accordance with the present disclosure.

FIG. 13 is a diagram illustrating an example process performed, for example, at a UE or an apparatus of a UE, in accordance with the present disclosure.

FIG. 14 is a diagram illustrating an example of an implementation of code and circuitry for an apparatus, in accordance with the present disclosure.

### DETAILED DESCRIPTION

Aspects of the present disclosure provide apparatuses, methods, processing systems, and computer-readable mediums for cell measurement with a low-power wakeup radio (LP-WUR).

A user equipment (UE) may communicate using a main radio (MR) of the UE. For example, the MR may handle uplink and downlink communications between the UE and a network entity, sidelink communications between the UE and other UEs, or the like. The MR may include various transmission and reception components such as one or more antennas, processor circuitry, a power amplifier, a low-noise amplifier, converters, or the like. These components may consume power in the course of operation and can be switched into a low-power state, such as an off state or a power saving mode.

To save power, a UE may implement a second radio referred to as an LP-WUR. The LP-WUR may include a radio receiver circuit designed to have a lower energy consumption than the MR. The UE may use the LP-WUR to establish or maintain synchronization or perform measurements (using a low-power synchronization signal (LP-SS)) and/or to detect paging. For example, when there is no data for the UE to receive from the network, the MR may enter a sleep state referred to as an ultra-low power state (ULPS) unless there is data for the UE to transmit. The sleep state may involve powering down one or more of the components described above. While the MR is in the sleep state, the LP-WUR may monitor for low-power wakeup signals (LP-WUSs). When there is data to receive, the network may transmit an LP-WUS, such as an on-demand LP-WUS. The LP-WUR may receive the LP-WUS and may trigger the MR to wake up (e.g., exit the sleep state). The MR may transmit and/or receive data after waking up.

The LP-WUS may assist with reducing power consumption tied to reception of paging at a given UE. For example, the LP-WUS may be transmitted only if paging is needed for idle or inactive mode UEs. If the LP-WUS is detected by the LP-WUR, the UE may activate the MR. The MR may synchronize to a synchronization signal block, and may receive paging on a paging occasion. If the LP-WUS is not detected, the MR may stay in the sleep mode, thereby saving power.

A UE may switch between various radio resource control (RRC) states (sometimes referred to as modes) in the course of operation. These RRC states may include an idle mode, an inactive mode, and a connected mode. The UE may start in an idle mode upon powering up. Upon establishing an RRC connection with a radio access network (RAN), the UE may move into a connected mode. In the connected mode, the UE may communicate data with the network via a connection on a cell, and the network may know which cell the UE is connected to. When the connection is released, the UE may move from the connected mode to an inactive mode. In the inactive mode, the UE may receive system information, perform cell reselection, and monitor for paging (e.g., RAN paging) according to a discontinuous reception (DRX) cycle. A DRX cycle may generally define recurring inactive times in which the UE (e.g., an MR of the UE) is in a sleep state and does not have to monitor for paging or a control channel, and recurring active times in which the UE monitors for paging (in idle mode DRX) or a control channel (in connected mode DRX).

As mentioned, in the inactive mode (and in the idle mode), the UE may perform cell reselection. Cell reselection involves measuring a serving cell's signal strength and/or quality to determine whether a cell selection criterion(S) is satisfied. If the cell selection criterion is not satisfied (indicating poor signal strength and/or quality on the serving cell), the UE may start measuring neighbor cells indicated by the serving cell. Thus, the UE can identify an appropriate neighbor cell for reselection (referred to as camping on or reselecting to the neighbor cell) when the serving cell's signal strength or quality deteriorates. If the UE is to transmit or receive a data communication, the UE may initiate a connection with the neighbor cell, thereby entering the connected mode and informing the network of the cell on which the UE is camped.

Cell reselection may involve periodic measurements of the serving cell. Measurement occasions for these periodic measurements may be derived from the UE's DRX cycle. For example, the UE may perform cell measurements in every DRX cycle, or in a subset of DRX cycles. In some deployments, an idle mode UE's MR may frequently wake up to perform the cell measurements, which may hamper the effectiveness of the LP-WUR. The UE can use the LP-WUR for cell measurements, which may consume less power relative to using the MR. However, it may be unsuitable for the LP-WUR to perform all cell reselection related measurements, particularly measurements on neighbor cells, for example, due to reliability of the LP-SS measurements. Since the LP-SS is a different signal from the SSBs which are typically used for measurements, the UE may not want to give full control to the LP-SS based measurements depending on various factors such as channel conditions, mobility conditions (e.g., a fast or slow moving UE), UE location (e.g., cell-center or cell edge). Depending on such factors, the UE may offload some of the measurements (fewer in some cases, more in others) to the LP-WUR. Thus, performing cell reselection measurements using only the MR may consume power and reduce the power saving effect of the LP-WUR, whereas performing cell reselection measurements using only the LP-WUR may be less reliable or undesirable for the UE.

Aspects of the present disclosure relate generally to LP-WURs. Some aspects more specifically relate to idle or inactive mode cell measurements by a UE using an LP-WUR. In some aspects, the UE may perform (in accordance with the UE's DRX cycle) one or more first cell measurements using an MR of the UE and one or more second cell measurements using an LP-WUR of the UE. A quantity of the one or more first cell measurements, and a quantity of the one or more second cell measurements, may be in accordance with a parameter which may be referred to herein as an offloading parameter. For example, the offloading parameter may generally indicate when to offload cell measurements from the MR to the LP-WUR. In some aspects, the UE may evaluate a cell selection criterion according to the one or more first cell measurements and/or the one or more second cell measurements.

In some aspects, the parameter may indicate a distribution of the one or more first cell measurements and the one or more second cell measurements. For example, the parameter may indicate (explicitly or implicitly) an integer R, and the MR and LP-WUR may perform every Rth cell measurement and the remaining (R minus 1) cell measurements, respectively. As another example, the parameter may indicate a duration, and the LP-WUR may perform cell measurements during the duration, until the MR resumes cell measurements after the duration. In some aspects, the UE may evaluate the cell selection criterion while the MR is in a sleep state. For example, the UE may trigger the MR to wake up from the sleep state in association with evaluating the cell selection criterion. In some other aspects, the UE (e.g., the MR) may evaluate the cell selection criterion using the one or more second cell measurements (performed by the LP-WUR). For example, the UE may store the one or more second cell selection measurements until the MR wakes up from the sleep state, and the MR may then evaluate the one or more second cell measurements. In some aspects, the UE may perform the one or more first cell measurements and the one or more second cell measurements in accordance with a scaling factor. For example, the UE may apply the scaling factor when the UE satisfies a relaxation criterion.

Aspects of the present disclosure may be used to realize one or more of the following potential advantages. In some aspects, by performing the one or more first cell measurements and the one or more second cell measurements in accordance with the offloading parameter, a balance is achieved between power saving by using the LP-WUR and acquiring system information or performing finer measurement by using the MR.

In some aspects, by indicating a distribution of the one or more first cell measurements and the one or more second cell measurements, the offloading of cell measurements to the LP-WUR can be tailored for different UE capabilities, measurement types, or other conditions, thereby improving efficiency and flexibility relative to a fixed distribution. In some aspects, by configuring the MR and LP-WUR to perform every Rth cell measurement and the remaining (R minus 1) cell measurements, a cyclical offloading approach is achieved, thereby simplifying implementation. By configuring the distribution using the duration, the MR can trigger a start of the duration, for example, based on conditions at the MR, thereby enabling on-demand offloading. By evaluating the cell selection criterion while the MR is in a sleep state, power and storage space is conserved relative to waking up the MR to perform the evaluation or storing the second cell measurements until the MR wakes up. By evaluating the cell selection criterion using the MR and the one or more second cell measurements (performed by the LP-WUR), more complex evaluation is enabled than if the LP-WUR evaluates the second cell measurements. By performing the one or more first cell measurements and the one or more second cell measurements in accordance with the scaling factor, measurement overhead is reduced in situations where more frequent measurement is unlikely to provide additional useful information, thereby conserving power relative to an approach where no relaxation criterion is implemented.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

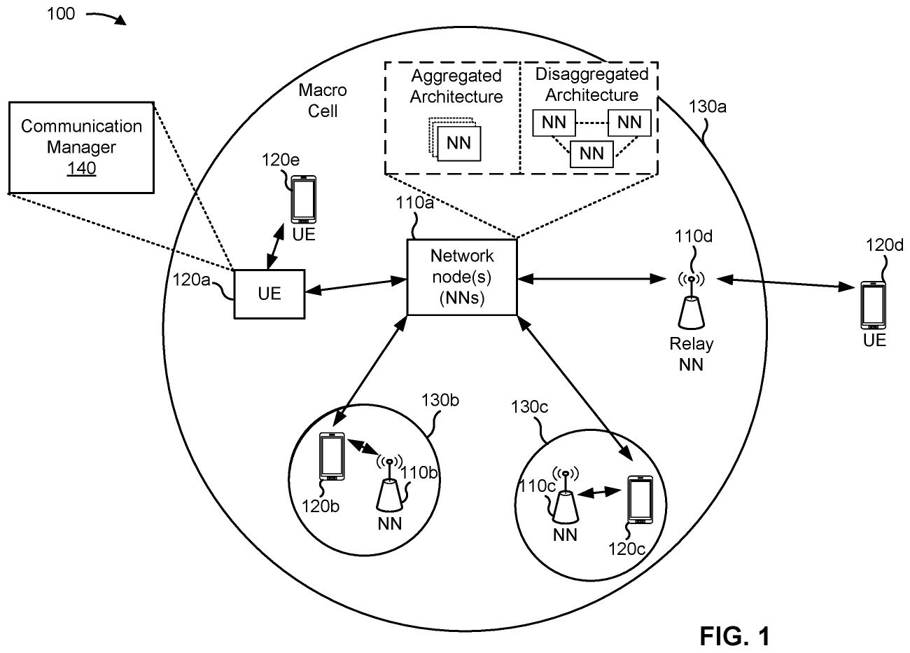

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHZ through 114.25 GHz), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a configuration of a DRX cycle; perform, in accordance with the DRX cycle, one or more first cell measurements using a main radio of the UE and one or more second cell measurements using an LP-WUR of the UE, wherein a quantity of the one or more first cell measurements and a quantity of the one or more second cell measurements are in accordance with a parameter; evaluate a cell selection criterion according to at least one of the one or more first cell measurements or the one or more second cell measurements; and transmit a communication in accordance with the one or more first cell measurements, the one or more second cell measurements, or the cell selection criterion. Additionally, or alternatively, the communication manager 140 may perform one or more other operations described herein.

As indicated above, FIG. 1 is provided as an example. Other examples may differ from what is described with regard to FIG. 1.

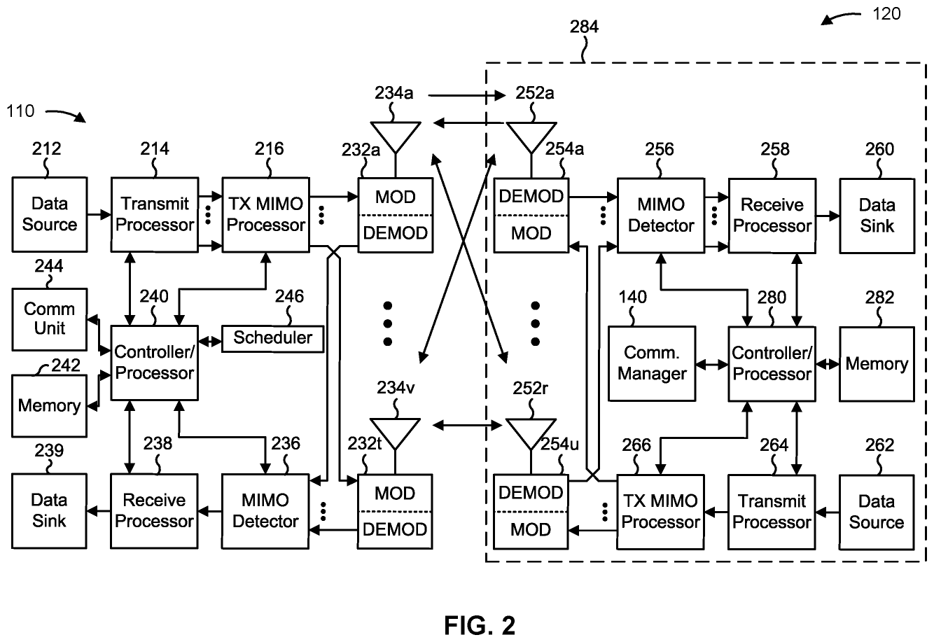

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

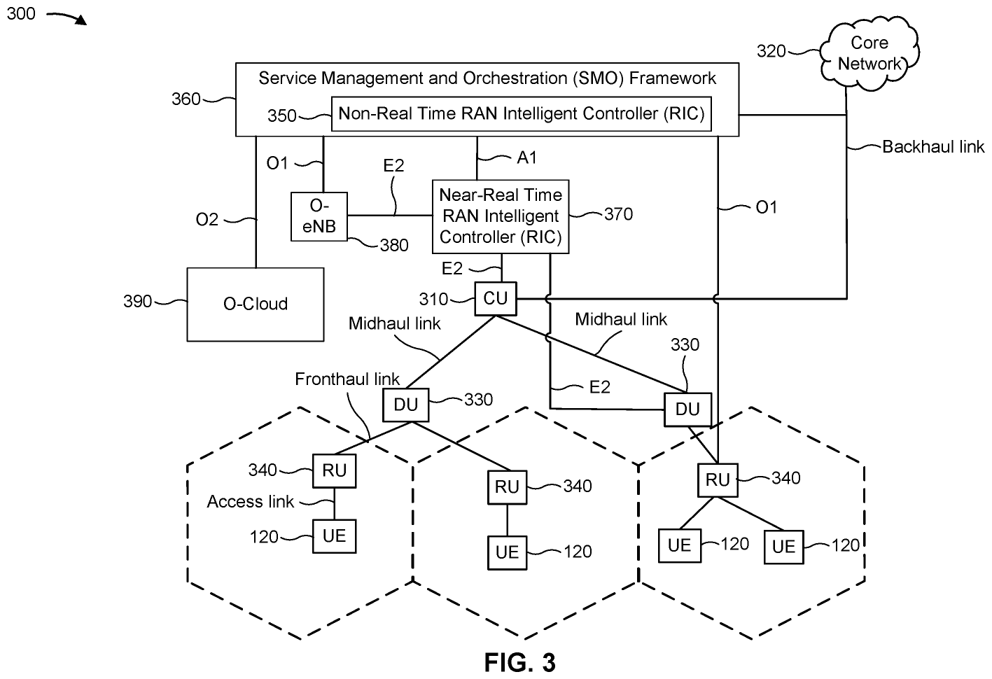

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 325 (for example, via an E2 link). The CU 310 May communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

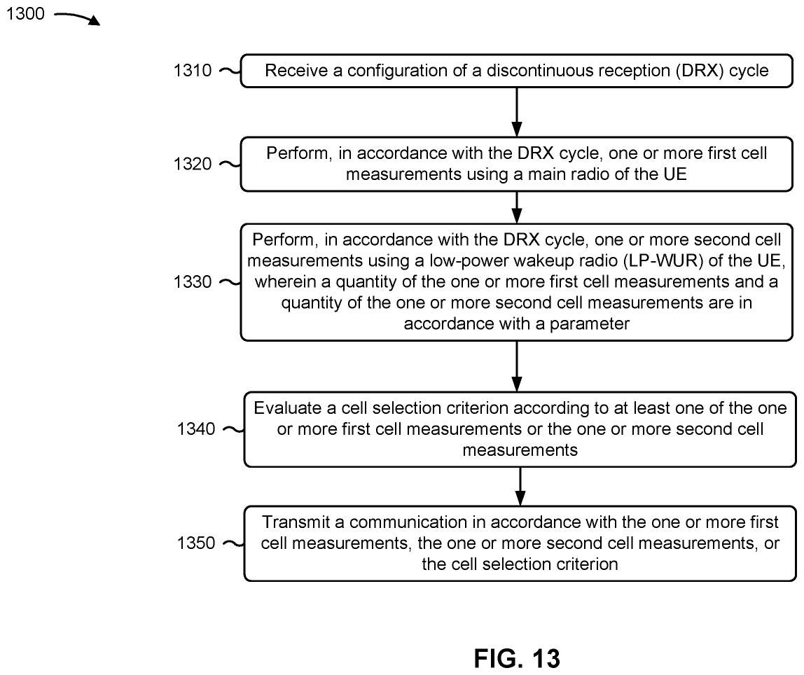

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an LP-WUR, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, or other processes as described herein. In some examples, executing instructions may include running the instructions, converting the instructions, compiling the instructions, and/or interpreting the instructions, among other examples.

In some aspects, the UE 120 includes means for receiving a configuration of a DRX cycle; means for performing, in accordance with the DRX cycle, one or more first cell measurements using a main radio of the UE and one or more second cell measurements using an LP-WUR of the UE, wherein a quantity of the one or more first cell measurements and a quantity of the one or more second cell measurements are in accordance with a parameter; means for evaluating a cell selection criterion according to at least one of the one or more first cell measurements or the one or more second cell measurements; and/or means for transmitting a communication in accordance with the one or more first cell measurements, the one or more second cell measurements, or the cell selection criterion. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

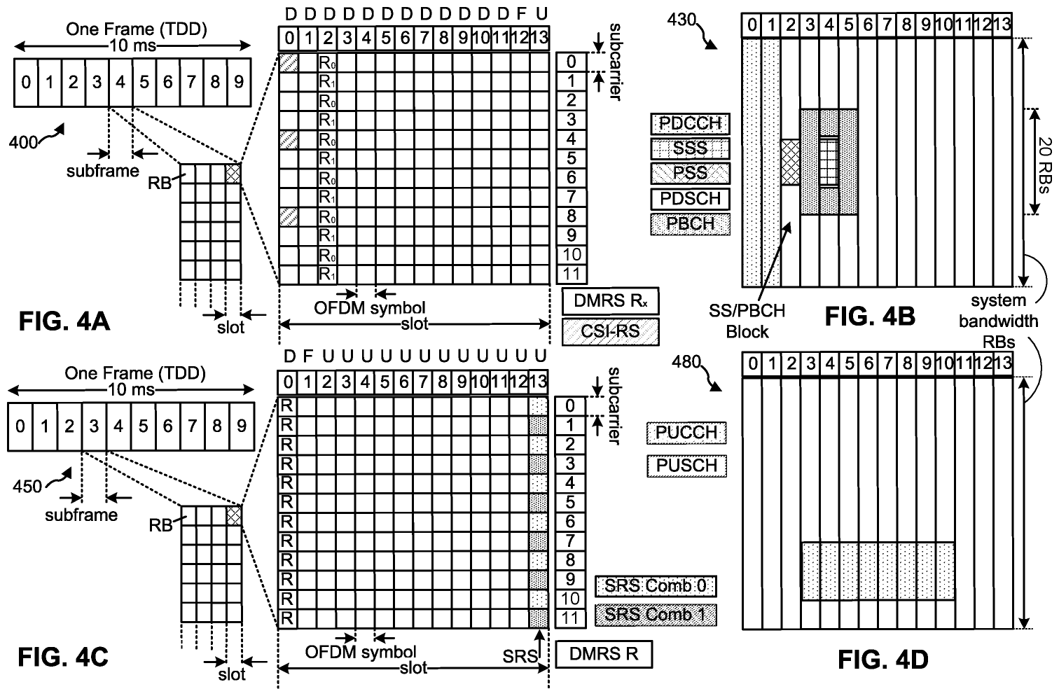

FIGS. 4A, 4B, 4C, and 4D depict aspects of data structures for a wireless communications network, such as wireless network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

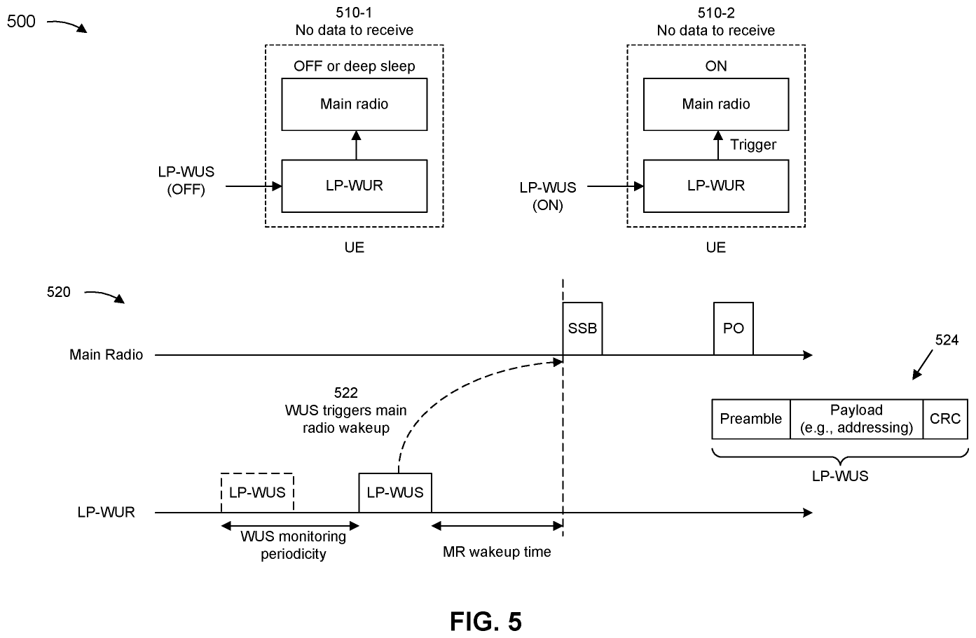

FIG. 5 is a diagram illustrating an example 500 of a low-power wakeup radio or receiver (LP-WUR) and a low-power wakeup signal (LP-WUS), in accordance with the present disclosure. As shown in FIG. 5, a UE (e.g., UE 120) may be equipped with a communication system that includes a main radio (MR) and an LP-WUR to reduce power consumption and enable low latency. For example, power saving and low latency are often conflicting goals because placing one or more components (such as an MR) into a sleep state more often to reduce power consumption also increases latency (e.g., because data cannot be transmitted and/or received while the one or more components are in the sleep state). Furthermore, in cases where the time that one or more components spend in a sleep state is reduced to reduce latency, power consumption may increase. Accordingly, as shown in FIG. 5, the UE may be equipped with the LP-WUR, which is a companion receiver that may be used with a MR to reduce power consumption and reduce latency.

For example, in some aspects, the UE may generally use the MR to transmit and/or receive user data, and the MR may be turned off or operated in a deep sleep state (e.g., a power state associated with one relative power unit, as defined in 3GPP Technical Report (TR) 58.840) unless there is user data to transmit and/or receive. Furthermore, the LP-WUR may serve as a simple wakeup receiver for the MR (e.g., the LP-WUR may not include a transmitter), and the LP-WUR may be active and monitoring for an LP-WUS while the MR is off or in the deep sleep state. For example, reference number 510-1 depicts a first state associated with the MR and the LP-WUR in cases where there is no user data that the MR needs to receive. In such cases, the MR may be off or in the deep sleep state unless there is user data to transmit, and the LP-WUR may actively monitor for an LP-WUS (e.g., continuously or periodically in monitoring occasions that are separated in time). Furthermore, reference number 510-2 depicts a second state associated with the MR and the LP-WUR where there is user data that the MR needs to receive. In such cases, the LP-WUR may receive an LP-WUS (e.g., from a network node) and the LP-WUR or the UE may provide a trigger to wake or otherwise activate the MR based on detecting the LP-WUS. Accordingly, the MR may then transmit and/or receive user data.

In general, the LP-WUR may consume very little power (e.g., a target power consumption less than 100 microwatts (μW) in the active state), which may be achieved using simple modulation schemes (e.g., on-off-keying (OOK)), a narrow bandwidth (e.g., less than 5 MHz), and/or other suitable techniques. In this way, the LP-WUR can be used to reduce the time that the MR spends in an on state and/or may avoid unnecessarily waking the MR from the off or deep sleep state when there is no user data to transmit or receive, which tends to be costly from a power consumption perspective. Furthermore, because the LP-WUR has a very low power consumption, the LP-WUR can be used to frequently or continuously perform LP-WUS monitoring, which may improve latency because the MR can be woken up when there is user data that the MR needs to receive (e.g., the LP-WUR does not suffer from the latency versus power efficiency tradeoff associated with duty cycling schemes, such as discontinuous reception (DRX)). Furthermore, in addition to performing LP-WUS monitoring, which is mainly targeted at paging reception, the LP-WUR may monitor a low power reference signal (LP-RS) for time and frequency tracking and radio resource management (RRM) measurement. In this way, by monitoring the LP-RS, serving cell and/or neighbor cell monitoring can be offloaded from the MR to the LP-WUR to reduce how often the MR is woken up and thereby reduce power consumption.

In some aspects, as shown by reference number 520, one application for the LP-WUR is to monitor the LP-WUS for paging monitoring, which can be used to reduce unnecessary paging reception performed by the MR. For example, as shown in FIG. 5, the LP-WUR may be configured to monitor for an LP-WUS (e.g., while the MR is off or in a deep sleep state) according to a wakeup signal (WUS) monitoring periodicity (e.g., the LP-WUR may monitor for the LP-WUS in periodic LP-WUS monitoring occasions that are separated in time by the WUS monitoring periodicity). Alternatively, although not explicitly shown in FIG. 5, the LP-WUR may be configured to continuously monitor for the LP-WUS. In general, a network node may transmit an LP-WUS to a UE only in cases where there is a paging message that needs to be sent to the UE while the UE is in an idle or inactive state (e.g., a radio resource control (RRC) idle or RRC inactive state). In such cases, as shown by reference number 522, the LP-WUR may receive and detect the LP-WUS, which may trigger the LP-WUR to wake up the MR. For example, as shown by reference number 524, the LP-WUS may be a message-based WUS, which may correspond to a packet that includes a preamble, a payload (e.g., a cell identifier or UE addressing for a paging early indication), and a cyclic redundancy code (CRC). Alternatively, in some aspects, the LP-WUS may be a sequence-based WUS, which may include a set of sequences that depend on a cell identifier and/or an identifier associated with the UE. In either case, as shown, the MR may wake up after a MR wakeup time, and may then start to monitor one or more synchronization signal block (SSB) transmissions to obtain synchronization with the network node before monitoring and receiving the paging message in a subsequent paging occasion (PO). Otherwise, in cases where the LP-WUR does not detect the LP-WUS, the MR may remain in the deep sleep state to save power.

As indicated above, FIG. 5 is provided as an example. Other examples may differ from what is described with regard to FIG. 5.

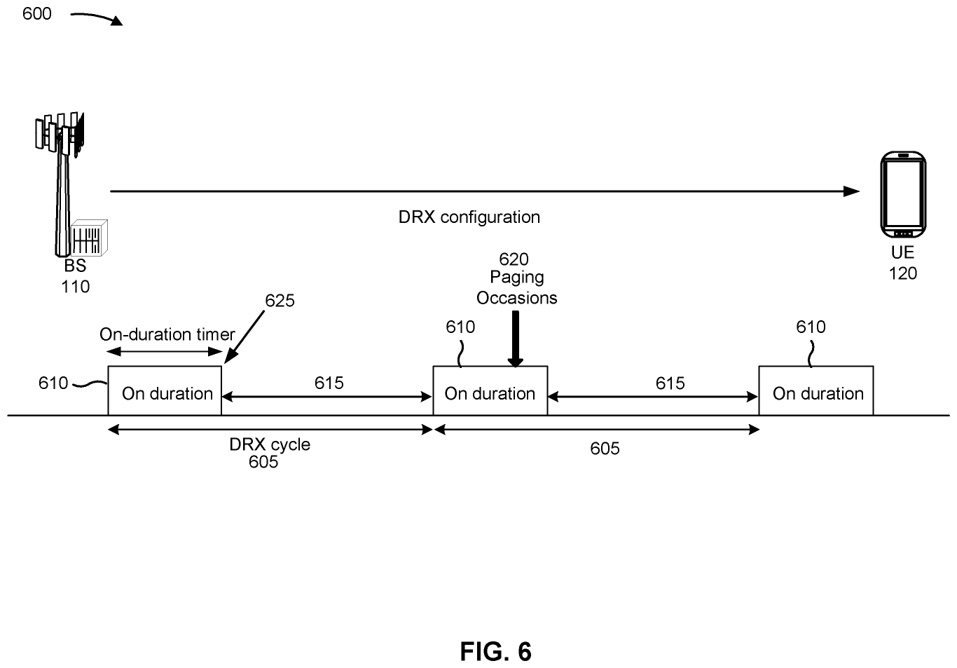

FIG. 6 is a diagram illustrating an example 600 of a DRX configuration, in accordance with the present disclosure.

As shown in FIG. 6, a network node 110 may transmit a DRX configuration to a UE 120 to configure a DRX cycle 605 for the UE 120. A DRX cycle 605 may include a DRX on duration 610 (e.g., during which a UE 120 is awake or in an active state) and an opportunity to enter a DRX sleep state 615. In some aspects, the DRX cycle 605 may be an extended DRX (eDRX) cycle. As used herein, the time during which the UE 120 is configured to be in an active state during the DRX on duration 610 may be referred to as an active time, and the time during which the UE 120 is configured to be in the DRX sleep state 615 may be referred to as an inactive time. As described below, the UE 120 may monitor for paging or a physical downlink control channel (PDCCH) during the active time, and may refrain from monitoring the paging or PDCCH during the inactive time.

During the DRX on duration 610 (e.g., the active time), the UE 120 may monitor POs, as shown by reference number 620. For example, the UE 120 may monitor the POs for RAN paging pertaining to the UE 120. If the UE 120 does not detect any paging for the UE 120 during the DRX on duration 610, then the UE 120 may enter the sleep state 615 (e.g., for the inactive time) at the end of the DRX on duration 610, as shown by reference number 625. In this way, the UE 120 may conserve battery power and reduce power consumption. As shown, the DRX cycle 605 may repeat with a configured periodicity according to the DRX configuration.

As indicated above, FIG. 6 is provided as an example. Other examples may differ from what is described with respect to FIG. 6.

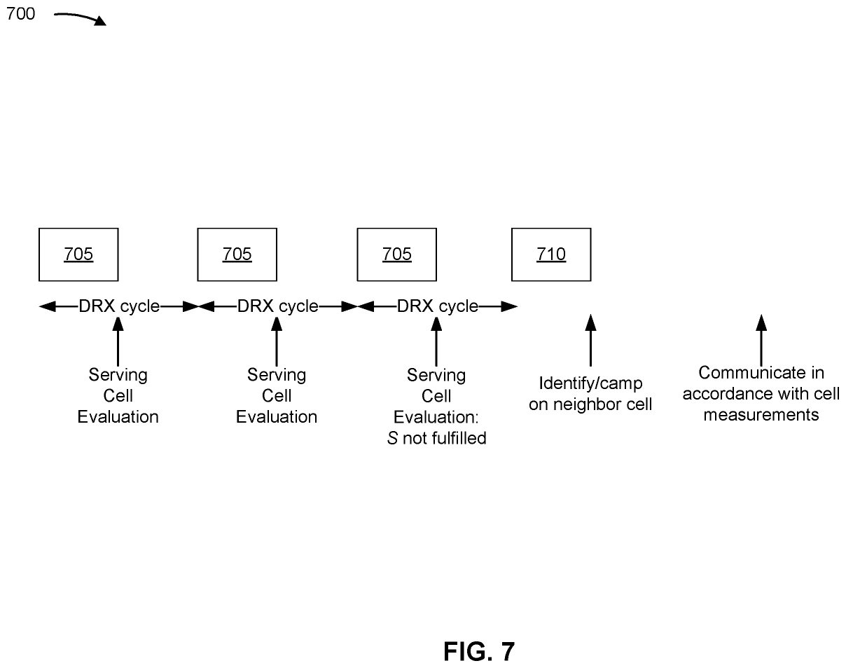

FIG. 7 is a diagram illustrating an example 700 of RRM measurement, in accordance with the present disclosure. Example 700 indicates a number of cell measurements 705 performed by a UE 120. A cell measurement 705 may include, for example, a reference signal received power (RSRP) measurement (e.g., a synchronization signal RSRP (SS-RSRP) measurement), a reference signal received quality (RSRQ) measurement (e.g., a synchronization signal RSRQ (SS-RSRQ) measurement), or the like. The cell measurements 705 may be on a serving cell of the UE 120.

As shown, the UE 120 may evaluate a cell selection criterion(S) using the cell measurements 705 (shown as “serving cell evaluation”). In example 700, the UE 120 evaluates the cell selection criterion once per DRX cycle (e.g., DRX cycle 605). In some aspects, the UE 120 may evaluate the cell selection criterion at least once every M1*N1 DRX cycles. M1 is 2 if an SSB measurement timing configuration (SMTC) periodicity (TSMTC) is greater than 20 ms and a length of the DRX cycle is less than or equal to 0.64 seconds, and otherwise M1 is 1. N1 is a beamsweeping scaling factor, where N1 is 1 for FR1, N1 is less than or equal to 8 for FR2-1, and N1 is less than or equal to 12 for FR2-2.

In some aspects, the UE 120 may filter the cell measurements 705. For example, the UE 120 may filter the SS-RSRP and SS-RSRQ measurements of the serving cell using at least 2 measurements (such as by performing averaging or weighted averaging of the measurements). Within the set of measurements used for the filtering, at least two measurements may be spaced apart by at least one-half a DRX cycle length.

If the UE 120 has evaluated, in a number (Nₛₑᵣᵥ) of consecutive DRX cycles, that the serving cell does not fulfill the cell selection criterion S, the UE 120 may initiate cell measurements 710 of neighbor cells indicated by the serving cell. The cell measurements 710 may be intra-frequency cell measurements or inter-frequency cell measurements. The cell measurements 705 and the cell measurements 710 may be collectively referred to as RRM measurements. The UE 120 may identify a neighbor cell on which to camp in accordance with the cell measurements 710. The UE 120 may communicate in accordance with at least one of the cell measurements 705 or the cell measurements 710. For example, the UE 120 may initiate a connection on the camped neighbor cell, for example, by transmitting a random access message.

As indicated above, FIG. 7 is provided as an example. Other examples may differ from what is described with regard to FIG. 7.

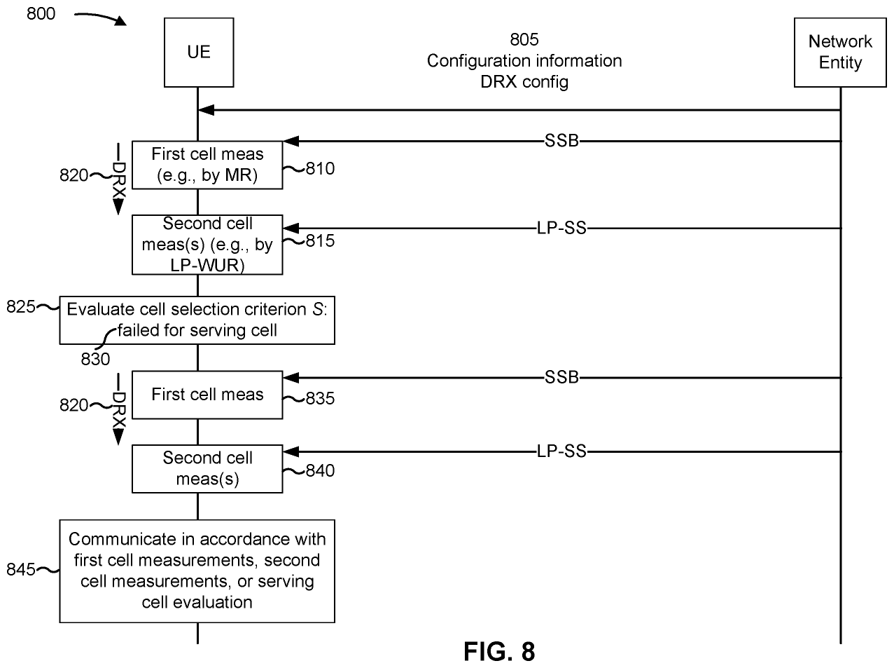

FIG. 8 is a diagram illustrating an example 800 of signaling for RRM measurement offloading, in accordance with the present disclosure. Example 800 includes a UE (such as UE 120) and a network entity, such as a network node 110 or a component of a disaggregated base station. In example 800, cell measurements are performed in every DRX cycle. In some aspects, cell measurements are performed in a subset of DRX cycles, such as in every Nth DRX cycle, as described elsewhere herein. In these aspects, the offloading parameter may be applied in connection with every Nth DRX cycle.

As shown by reference number 805, the network entity may transmit, and the UE may receive, configuration information. In some aspects, the configuration information may include RRC information, system information, MAC signaling, DCI, or a combination thereof.

In some aspects, the configuration information may include a DRX configuration, as described in connection with FIG. 6. The DRX configuration may configure a DRX cycle (e.g., DRX cycle 605), which may include an extended DRX (eDRX) cycle or a non-extended DRX cycle.

In some aspects, the configuration information may indicate a set of values for a parameter referred to herein as an offloading parameter. The offloading parameter may indicate (explicitly or implicitly) a quantity of first cell measurements and a quantity of second cell measurements. For example, the offloading parameter may indicate a distribution of first cell measurements and second cell measurements (such as a distribution in terms of an integer factor identifying which cell measurements are second cell measurements, or in terms of a duration in which cell measurements are second cell measurements). For example, the configuration information may include a set of values from which the offloading parameter can be selected. In some aspects, the set of values may include values for a factor R, described in more detail below. Additionally, or alternatively, the set of values may include values for a duration D, which is also described in more detail below. In some aspects, the set of values may be configured for a specific UE (e.g., via UE-specific signaling). In some aspects, the set of values may be configured for a group of UEs (e.g., via group signaling to the group of UEs). In some aspects, the set of values may be specific to a frequency range, where frequency ranges are defined elsewhere herein. For example, the configuration information may indicate or be associated with a frequency range for which the set of values are used. In some aspects, the set of values may be specific to a frequency band, such as a frequency band defined by the 3GPP. For example, the configuration may indicate or be associated with a frequency band for which the set of values are to be used. In some aspects, the set of values may be determined according to a function. For example, the set of values may be determined as 2*n or 2ⁿ, where n includes one or more values (e.g., [0 1 2 3]). In some aspects, the set of values may include a pre-determined set of values, for example, defined in a wireless communication specification.

As an example, the set of values may include [1 2 4 8]. In this example, when 1 is selected from the set of values as the offloading parameter (i.e., when R is 1), all cell measurements may be performed by the MR. When R is 2, the MR and the LP-WUR may alternatively perform cell measurements. When R is 4, the MR may perform cell measurements in every 4^{th} DRX/eDRX cycle. When R is 8, the MR may perform cell measurements in every 8^{th} DRX/eDRX cycle.

In some aspects, the offloading parameter may indicate a duration D, and the LP-WUR may perform cell measurements during the duration D. For example, the configuration information may indicate a value of the duration D or may include a set of values from which the duration D can be selected or determined. In some aspects, the UE 120 (e.g., the MR) may select or determine a value of the duration D, as described below. In some aspects, D may be specified as a multiple of DRX/eDRX cycles. For example, a value of “5” for D may indicate that the LP-WUR is to perform cell measurements in a next 5 DRX/eDRX cycles. In some aspects, the UE 120 (e.g., the MR) may trigger second measurements (shown by reference numbers 815 and 840) according to the duration D. For example, the UE 120 (e.g., the MR) may trigger offloading of measurements to the LP-WUR for a length of the duration D, such as based on a criterion being satisfied. The criterion may include, for example, a stationary criteria (e.g., indicating whether the UE 120 is stationary, a low-mobility criteria (e.g., indicating whether the UE 120 is associated with a low mobility condition), a not-at-cell-edge criteria (e.g., indicating whether the UE 120 is located at a cell edge), a measurement criterion e.g., indicating whether the UE 120 meets an absolute or relative threshold for a measurement such as an RSRP or RSRQ measurement), or a combination thereof. In some aspects, different values D can be used for a 120 UE meeting different criteria of the above criteria. In this example, in some aspects, a single first cell measurement of the MR may be included in the duration D (e.g., the duration D may start at the single first cell measurement), or no first cell measurements may be included in the duration D. Triggering a start of the duration D may include one or more of entering a sleep state of the MR, providing an indication for the LP-WUR to start second cell measurements, or providing an indication that the duration D has begun.

In some aspects, the UE 120 may select a value of the offloading parameter. For example, the UE 120 may select the value of the offloading parameter using a length of the DRX cycle. In this example, larger values of R or D can be specified for shorter DRX cycles to ensure an MR's sleep duration is not reduced for a short DRX cycle. As another example, the UE 120 may select the value of the offloading parameter using a frequency range of a serving cell of the UE 120. For example, the UE 120 may select a first value of the offloading parameter for cell measurements in a first frequency range and may select a second value of the offloading parameter for cell measurements in a second frequency range. As another example, the UE 120 may select the value of the offloading parameter using a frequency band of the serving cell. For example, the UE 120 may select a first value of the offloading parameter for cell measurements in a first frequency band and may select a second value of the offloading parameter for cell measurements in a second frequency band. In this example, an FR2 band may benefit from frequent measurements because of higher channel variation and beamforming, so a smaller R or D may be used as compared to an FR1 band. As another example, the UE 120 may select the value of the offloading parameter using a frequency gap between an SSB of the one or more first cell measurements and an LP-SS of the one or more second cell measurements. For example, the UE 120 may select a smaller offloading parameter (corresponding to more consecutive measurements by the LP-WUR) for a larger frequency gap, as the measurements may not be highly correlated between a frequency of the LP-SS and a frequency of the SSB in this case. As another example, the UE 120 may select the value of the offloading parameter using a transmission periodicity of the LP-SS. For example, the UE 120 may select the offloading parameter such that cell measurements by the LP-WUR are aligned with transmissions of the LP-SS according to the transmission periodicity of the LP-SS. As another example, a larger LP-RS transmission periodicity may imply fewer and insufficient measurements, so the UE 120 may select a lower value of R or D. As another example, the UE 120 may select the value of the offloading parameter using a bandwidth of the LP-SS. For example, a smaller LP-RS bandwidth may imply less accurate measurements than a larger LP-RS bandwidth, so the UE 120 may select a lower value of R or D. As another example, the UE 120 may select the value of the offloading parameter using a class of the UE, such as a mobility class. For example, stationary UEs may use a larger value of R or D, while highly mobile UEs may use a smaller value of R or D. As another example, the UE 120 may select the value of the offloading parameter using a capability of the UE. As another example, the UE 120 may select the value of the offloading parameter using the cell selection criterion. For example, if the UE 120 meets cell-selection criteria by a threshold margin (indicating good cell conditions), the UE 120 may use a larger value of R or D. A lower margin may lead to smaller values of R or D.

In some aspects, the configuration information may indicate a filtering configuration, such as a time window for application of filtering, a number of cell measurements to be filtered, one or more filtering parameters (e.g., weights), or the like. The UE 120 may perform filtering (e.g., time domain averaging and/or weighted averaging) across first cell measurements by the MR (e.g., SSB-based measurements) and second cell measurements by the LP-WUR (e.g., LP-SS-based measurements). For example, the UE 120 may perform time-domain averaging and/or weighted averaging of at least one first cell measurement and at least one second cell measurement.

As shown by reference number 810, the UE 120 may perform one or more first cell measurements using an MR of the UE 120. The one or more first cell measurements may be measurements of an SSB transmitted by a serving cell. As shown by reference number 815, the UE 120 may perform one or more second cell measurements using an LP-WUR of the UE 120. The one or more second cell measurements may be measurements of an LP-SS transmitted by the serving cell. While the LP-WUR performs the one or more second cell measurements, the MR may be in a sleep state (e.g., a deep sleep).

As shown by reference number 820, the UE 120 may perform the one or more first cell measurements and the one or more second cell measurements in accordance with the DRX cycle. For example, the UE 120 may perform a first cell measurement or a second cell measurement in every DRX cycle (or in every Nth DRX cycle if cell measurements are configured to be performed in every Nth DRX cycle).

As shown by reference number 825, the UE 120 may evaluate a cell selection criterion(S), such as an Sᵣₓₗₑᵥ criterion or an S_{qual} criterion. A cell selection criterion may include one or more sub-criteria. When a serving cell fails to satisfy the cell selection criterion (e.g., for a number Nₛₑᵣᵥ of consecutive DRX cycles), the UE 120 may initiate cell measurements on one or more neighbor cells. For example, the UE 120 may initiate measurements on all neighbor cells indicated by the serving cell if the serving cell does not fulfil the cell selection criterion S in Nₛₑᵣᵥ consecutive DRX cycles. In example 800, the serving cell fails to satisfy the cell selection criterion (shown by reference number 830), so the UE 120 initiates first cell measurements shown by reference number 835 (by the MR) and second cell measurements shown by reference number 840 (by the LP-WUR) on one or more neighbor cells. In some aspects, these cell measurements may be performed only by the MR, or only by the LP-WUR. In some aspects, the cell measurements shown by reference numbers 835 and 840 may be performed using a different offloading factor than the cell measurements shown by reference numbers 810 and 815.

In some aspects, the UE 120 may evaluate the cell selection criterion while the MR is in a deep sleep (e.g., while measurement is offloaded to the LP-WUR, while the LP-WUR performs second cell measurements). For example, the LP-WUR may perform the cell selection criterion evaluation. This may conserve power that would otherwise be used by the MR performing the cell selection criterion evaluation.

In some aspects, the UE 120 may evaluate the cell selection criterion while the MR is awake. For example, the MR may perform the cell selection criterion evaluation. In this example, the UE 120 (e.g., the LP-WUR) may store (e.g., log) second cell measurements (e.g., corresponding to each DRX cycle) while the MR is in the sleep state. The UE 120 (e.g., the MR), upon the MR waking up, may perform serving cell evaluation for a last R consecutive DRX cycles, or for the length of a duration D.

In some aspects, the UE 120 (e.g., the LP-WUR) may trigger the MR to wake up. For example, the UE 120 may trigger the MR to wake up and perform serving cell criterion evaluation (also referred to as “serving cell evaluation”). As another example, the UE 120 may trigger the MR to wake up and perform neighbor cell measurements (e.g., first cell measurements 840). In some aspects, the UE 120 (e.g., the LP-WUR) may trigger the MR to wake up in association with evaluating the cell selection criterion. For example, the UE 120 (e.g., the LP-WUR) may evaluate that the serving cell has failed to satisfy the cell selection criterion in a number N_{serv-WUR} of consecutive DRX cycles, and may wake up the MR to evaluate the cell selection criterion and/or perform first cell measurements in accordance with the serving cell failing to satisfy the cell selection criterion in the number of consecutive DRX cycles. In some aspects, N_{serv-WUR} may be between 1 and Nₛₑᵣᵥ (inclusive). In some aspects, N_{serv-WUR} may be configured (such as in the configuration information shown by reference number 805 using RRC, system information, or the like), or may be pre-defined, such as in a wireless communication specification. As another example, the UE 120 (e.g., the LP-WUR) may trigger the MR to wake up and evaluate the cell selection criterion based on a measurement failing to satisfy a criterion, such as if an LP-WUR's second cell measurement falls below a threshold T (where T may be configured such as in the configuration information shown by reference number 805 using RRC, system information, or the like, or may be pre-defined, such as in a wireless communication specification).

In some aspects, the UE 120 may perform cell measurements shown by reference number 810, 815, 835, or 840 according to an adjusted value of the offloading parameter. For example, the UE 120 may adjust a value of the parameter (e.g., a value of a factor R or a value of a duration D) in accordance with a criterion Z being satisfied, which is referred to herein as an adaptive RRM measurement offloading mechanism. The criterion Z may be a defined criterion. In some aspects, Z may be based on a measurement threshold, such as a measurement value (e.g., an RSRP, an RSRQ, or the like) meeting a threshold. In some aspects, Z may be based on a measurement change threshold, such as a change in consecutive measurement values meeting a threshold. In some aspects, Z may be based on a combination of a measurement threshold and a measurement change threshold, such as a change in consecutive measurement values meeting a first threshold while a measurement value meets a second threshold.

As an example of adjusting the offloading parameter, the UE 120 may start with a most conservative offloading parameter (e.g., R=1 or D=0). The UE 120 (e.g., the MR) may evaluate a criterion Z, and may adjust (e.g., reconfigure) R or D with a larger value (e.g., a next value, such as a larger value that is closest to a current offloading parameter value) from the set of values configured for R or D upon determining that the criterion Z is satisfied. The MR may periodically evaluate the criterion Z, and may increase or decrease the value of the offloading parameter R or D from the corresponding set of values. The evaluation of the criterion Z may be performed at a uniform interval or a non-uniform interval. In some aspects (e.g., in addition to the MR), the LP-WUR may also evaluate Z (or a different criterion Z′ (Z prime)) and may accordingly use an updated value of R (or D) configured by the MR or may continue using the previous R (or D) depending on whether Z or Z′ is satisfied. The adaptive RRM measurement offloading mechanism provides power-savings optimizations based on long-term channel statistics.

In some aspects, the UE 120 may perform cell measurements 810, 815, 835, or 840 according to a relaxation criterion. For example, the UE 120 may apply a scaling factor to an offloading parameter R or D when a relaxation criterion is satisfied. The relaxation criterion may include, for example, a first criterion indicating that the UE 120 is stationary and not at a cell edge, a second criterion indicating that the UE 120 is stationary, a third criterion indicating that the UE 120 is a low-mobility UE and not at a cell edge, a fourth criterion indicating that the UE 120 is a low-mobility UE, a fifth criterion indicating that the UE 120 is not at a cell edge, or a combination thereof. The UE 120 may apply a scaling factor F if the UE meets one or more of the criteria described above. In some aspects, F may be configured via RRC signaling, system information, or the like. In some aspects, F may be pre-defined, such as in a wireless communication specification. In some aspects, F may be configured for a specific UE. In some aspects, F may be configured or specified for a group of UEs. In some aspects, F may be configured or specified for a type of UE, such as a UE having a particular class or mobility type. In some aspects, F may be specific to a frequency band and/or a frequency range. In some aspects, F may be specific to one or more criteria. For example, a first value of F may be configured and/or used when a first set of the above criteria are satisfied, and a second value of F may be configured and/or used when a second set of the above criteria are satisfied.

As an example, the second criterion may be satisfied for a UE having a reduced capability (RedCap) UE type operating in an FR1 frequency band. In this example, the value of F for this combination of UE type, criterion, and frequency range is 4, and the UE may apply the scaling factor F and modify R from 1 to 4. Thus, if the UE 120 does not satisfy the second criterion, then the UE 120 applies R=1, and if the UE 120 satisfies the second criterion, then the UE 120 applies R=4. As another example, for R=2, if the UE 120 does not satisfy the second criterion, then the UE 120 may apply R=2, and if the UE 120 satisfies the second criterion, then the UE 120 may apply R=8.

As shown by reference number 845, the UE 120 may communicate in accordance with one or more of the first cell measurements (shown by reference numbers 810 and 835), the second cell measurements (shown by reference numbers 815 and 840), or the serving cell evaluation. For example, the UE 120 may communicate in association with initiating a connection on a neighbor cell according to the serving cell evaluation and the first cell measurements and/or second cell measurements shown by reference number 835 and 840. As another example, the UE 120 or the network entity may communicate in association with initiating a connection on a serving cell according to the serving cell evaluation and/or the first cell measurements and/or second cell measurements shown by reference numbers 810 and 815.

Any of the techniques described above with regard to offloading cell measurements, such as those shown by reference numbers 810, 815, 835, and 840, can be applied for intra-frequency cell reselection and inter-frequency cell reselection.

As indicated above, FIG. 8 is provided as an example. Other examples may differ from what is described with regard to FIG. 8.

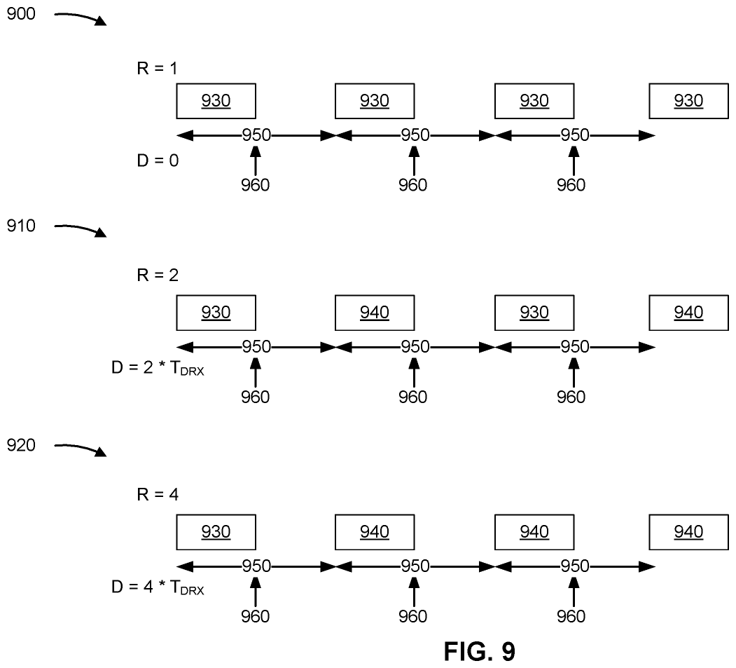

FIG. 9 is a diagram illustrating examples 900, 910, and 920 of serving cell measurements and evaluation according to an offloading parameter, in accordance with the present disclosure. First cell measurements are shown by reference number 930 and second cell measurements are shown by reference number 940. A DRX cycle length T_{DRX} is shown by reference number 950. The horizontal axis represents time. Cell selection criterion evaluation is indicated by reference number 960. In FIG. 9, cell selection criterion evaluation is performed after each cell measurement. In some aspects described herein, cell selection criterion evaluation may be performed after a subset of cell measurements.

Example 900 is an example where R is equal to 1 or D is equal to 0. In this example, the UE 120 (e.g., the MR) performs only first cell measurements (e.g., SSB-based measurements). In this example, no measurements are offloaded to the LP-WUR.

Example 910 is an example where R is equal to 2 or D is equal to 2*T_{DRX}. In this example, the MR performs every first cell measurement (shown by reference number 930) and the LP-WUR performs every second cell measurement (shown by reference number 940), where first cell measurements are every other cell measurement. For example, first cell measurements alternate with second cell measurements.

Example 920 is an example where R is equal to 4 or D is equal to 4*T_{DRX}. In this example, the MR performs a first cell measurement (shown by reference number 930) and the LP-WUR performs multiple second cell measurements (shown by reference number 940 and including 3 second cell measurements) for each first cell measurement.

As indicated above, FIG. 9 is provided as an example. Other examples may differ from what is described with regard to FIG. 9.

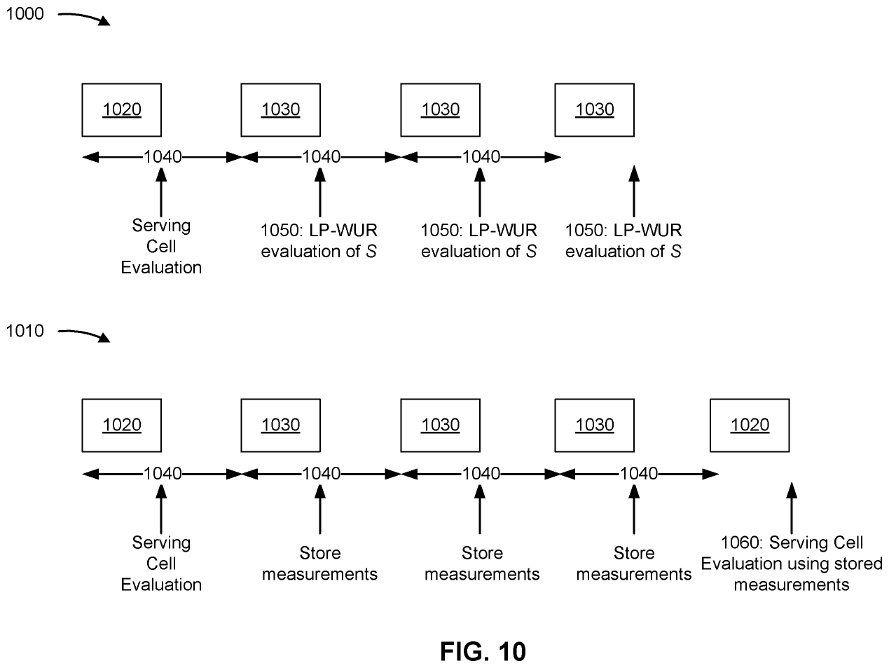

FIG. 10 is a diagram illustrating examples 1000 and 1010 of cell selection criterion evaluation, in accordance with the present disclosure. First cell measurements are shown by reference number 1020 and second cell measurements are shown by reference number 1030. A DRX cycle length T_{DRX} is shown by reference number 1040. The horizontal axis represents time. Cell selection criterion evaluation is indicated by reference number 1050 in example 1000 and reference number 1060 in example 1010. In examples 1000 and 1010, R is equal to 4 (or D is equal to 4*T_{DRX}).

Example 1000 is an example where the UE 120 (e.g., the LP-WUR) performs cell selection criterion evaluation at reference number 1050 while the MR is in a sleep state. Example 1010 is an example where the UE 120 (e.g., the LP-WUR) stores (e.g., logs) cell measurements shown by reference number 1030 until the MR wakes up. The MR then performs serving cell evaluation using the stored cell measurements, as shown by reference number 1060.

As indicated above, FIG. 10 is provided as an example. Other examples may differ from what is described with regard to FIG. 10.

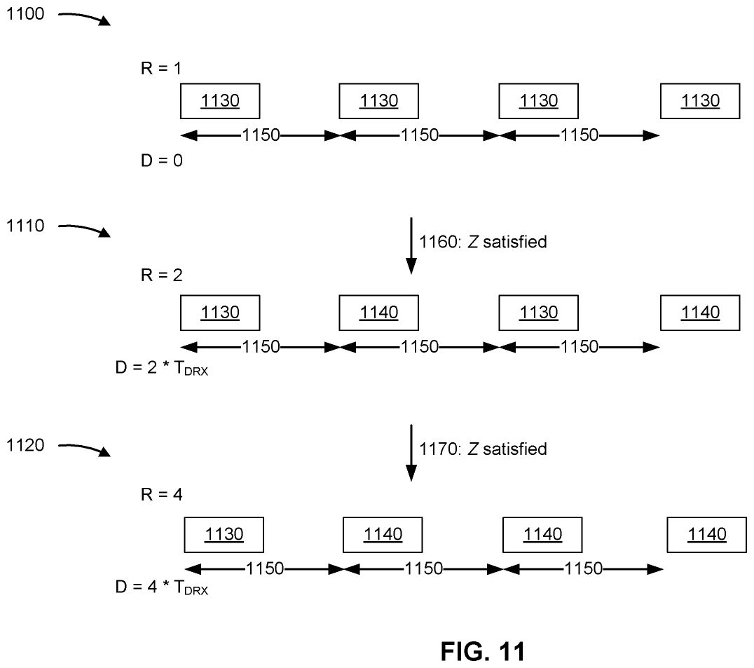

FIG. 11 is a diagram illustrating examples 1100, 1110, and 1120 of an adaptive RRM measurement offloading mechanism, in accordance with the present disclosure. First cell measurements are shown by reference number 1130 and second cell measurements are shown by reference number 1140. A DRX cycle length T_{DRX} is shown by reference number 1150. The horizontal axis represents time. Cell selection criterion evaluation is omitted in FIG. 11, and is described in more detail elsewhere herein. FIG. 11 shows application of an adjustment to an offloading parameter R when a UE 120 satisfies a criterion Z, as described with regard to FIG. 8.

In example 1100, R is equal to 1 (or D is equal to 0). In this example, the UE 120 (e.g., the MR) performs only first cell measurements (e.g., SSB-based measurements). In this example, no measurements are offloaded the LP-WUR.

As shown by reference number 1160, the criterion Z may be satisfied. For example, a first threshold of the criterion Z may be satisfied. As shown in example 1110, R is adjusted to 2 (or D is adjusted to 2*T_{DRX}). Thus, the MR performs every first cell measurement (shown by reference number 1130) and the LP-WUR performs every second cell measurement (shown by reference number 1140), where first cell measurements are every other cell measurement. For example, first cell measurements alternate with second cell measurements.

As shown by reference number 1170, the criterion Z may again be satisfied, such as according to a second threshold of the criterion Z different from the first threshold, or according to a different criterion or set of criterions than shown by reference number 1160. As shown in example 1120, R is adjusted to 4, or D is adjusted to 4*T_{DRX}. In this example, the MR performs a first cell measurement (shown by reference number 1130) and the LP-WUR performs multiple second cell measurements (shown by reference number 1140 and including 3 second cell measurements) for each first cell measurement.

As indicated above, FIG. 11 is provided as an example. Other examples may differ from what is described with regard to FIG. 11.

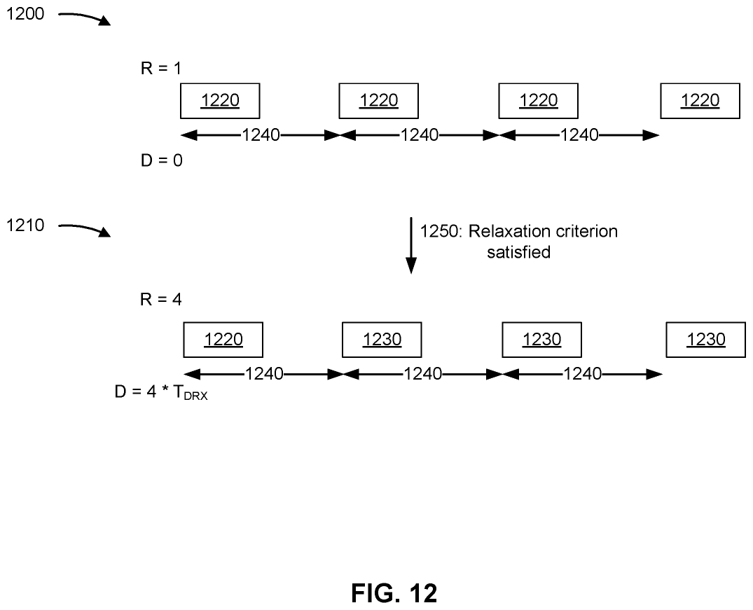

FIG. 12 is a diagram illustrating examples 1200 and 1210 of a scaling factor for measurement relaxation, in accordance with the present disclosure. First cell measurements are shown by reference number 1220 and second cell measurements are shown by reference number 1230. A DRX cycle length T_{DRX} is shown by reference number 1240. The horizontal axis represents time. Cell selection criterion evaluation is omitted in FIG. 12, and is described in more detail elsewhere herein. FIG. 12 shows application of a scaling factor F when a UE 120 satisfies a relaxation criterion, as described with regard to FIG. 8.

In example 1200, R is equal to 1 (or D is equal to 0). In this example, the UE 120 (e.g., the MR) performs only first cell measurements (e.g., SSB-based measurements). In this example, no measurements are offloaded the LP-WUR. As shown by reference number 1250, a relaxation criterion (e.g., a second criterion, corresponding to a stationary UE 120) may be satisfied. Thus, the UE 120 may apply a measurement relaxation factor F (also referred to as a scaling factor) in accordance with the relaxation criterion being satisfied. As shown in example 1210, R is adjusted to R*F=4 (or D is adjusted to R*D=4). Thus, the MR performs a first cell measurement (shown by reference number 1230) and the LP-WUR performs multiple second cell measurements (shown by reference number 1240 and including 3 second cell measurements) for each first cell measurement.

As indicated above, FIG. 12 is provided as an example. Other examples may differ from what is described with regard to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with cell measurement with a low-power wakeup radio.

As shown in FIG. 13, in some aspects, process 1300 may include receiving a configuration of a DRX cycle (block 1310). For example, the UE (e.g., using processing system 1402 and/or transceiver 1408) may receive a configuration of a DRX cycle, as described above.

As further shown in FIG. 13, in some aspects, process 1300 may include performing, in accordance with the DRX cycle, one or more first cell measurements using a main radio of the UE (block 1320). As further shown in FIG. 13, in some aspects, process 1300 may include performing, in accordance with the DRX cycle, one or more second cell measurements using a LP-WUR of the UE, wherein a quantity of the one or more first cell measurements and a quantity of the one or more second cell measurements are in accordance with a parameter (block 1330). For example, the UE (e.g., using processing system 1402 and/or transceiver 1408) may perform, in accordance with the DRX cycle, one or more first cell measurements using a main radio of the UE and one or more second cell measurements using a LP-WUR of the UE, wherein a quantity of the one or more first cell measurements and a quantity of the one or more second cell measurements are in accordance with a parameter, as described above.

As further shown in FIG. 13, in some aspects, process 1300 may include evaluating a cell selection criterion according to at least one of the one or more first cell measurements or the one or more second cell measurements (block 1340). For example, the UE (e.g., using processing system 1402) may evaluate a cell selection criterion according to at least one of the one or more first cell measurements or the one or more second cell measurements, as described above.

As further shown in FIG. 13, in some aspects, process 1300 may include transmitting a communication in accordance with the one or more first cell measurements, the one or more second cell measurements, or the cell selection criterion (block 1350). For example, the UE (e.g., using processing system 1402 and/or transceiver 1408) may transmit a communication in accordance with the one or more first cell measurements, the one or more second cell measurements, or the cell selection criterion, as described above.

Process 1300 may include additional aspects, such as any single aspect or any combination of aspects described below and/or in connection with one or more other processes described elsewhere herein.

In a first aspect, the one or more first cell measurements and the one or more second cell measurements are serving cell measurements.

In a second aspect, alone or in combination with the first aspect, the one or more first cell measurements use a synchronization signal block and the one or more second cell measurements use a low-power synchronization signal.

In a third aspect, alone or in combination with one or more of the first and second aspects, the parameter indicates a distribution of the one or more first cell measurements and the one or more second cell measurements.

In a fourth aspect, alone or in combination with one or more of the first through third aspects, the parameter indicates an integer R, wherein performing the one or more first cell measurements and the one or more second cell measurements comprises performing a first cell measurement of the one or more first cell measurements in every Rth iteration of the DRX cycle, and performing the one or more second cell measurements in remaining iterations of the DRX cycle other than every Rth iteration.

In a fifth aspect, alone or in combination with one or more of the first through fourth aspects, the parameter indicates a duration, wherein performing the one or more first cell measurements and the one or more second cell measurements comprises performing the one or more second cell measurements during the duration.

In a sixth aspect, alone or in combination with one or more of the first through fifth aspects, process 1300 includes triggering a start of the duration.

In a seventh aspect, alone or in combination with one or more of the first through sixth aspects, process 1300 includes receiving signaling that indicates a set of values for the parameter, and selecting a value from the set of values, wherein performing the one or more first cell measurements and the one or more second cell measurements is in accordance with the value of the parameter.

In an eighth aspect, alone or in combination with one or more of the first through seventh aspects, selecting the value comprises selecting the value using at least one of a length of the DRX cycle, a frequency range of a serving cell of the UE, a frequency band of the serving cell, a frequency gap between a synchronization signal block of the one or more first cell measurements and a low power synchronization signal of the one or more second cell measurements, a transmission periodicity of the low power synchronization signal, a bandwidth of the low power synchronization signal, a class of the UE, a capability of the UE, or the cell selection criterion.

In a ninth aspect, alone or in combination with one or more of the first through eighth aspects, evaluating the cell selection criterion comprises evaluating the cell selection criterion while the main radio is in a sleep state.

In a tenth aspect, alone or in combination with one or more of the first through ninth aspects, process 1300 includes triggering the main radio to wake up in association with evaluating the cell selection criterion.

In an eleventh aspect, alone or in combination with one or more of the first through tenth aspects, evaluating the cell selection criterion comprises evaluating, by the main radio, the cell selection criterion using the one or more second cell measurements.

In a twelfth aspect, alone or in combination with one or more of the first through eleventh aspects, process 1300 includes storing the one or more second cell measurements, prior to evaluating the cell selection criterion, while the main radio is in a sleep state.

In a thirteenth aspect, alone or in combination with one or more of the first through twelfth aspects, process 1300 includes triggering the main radio to wake up in accordance with the one or more second cell measurements failing to satisfy a threshold.

In a fourteenth aspect, alone or in combination with one or more of the first through thirteenth aspects, process 1300 includes adjusting a value of the parameter in accordance with a criterion being satisfied.

In a fifteenth aspect, alone or in combination with one or more of the first through fourteenth aspects, the criterion is associated with at least one of a measurement threshold, a measurement change threshold, or a combination thereof.

In a sixteenth aspect, alone or in combination with one or more of the first through fifteenth aspects, performing the one or more first cell measurements and the one or more second cell measurements comprises performing, in association with the UE satisfying a relaxation criterion, the one or more first cell measurements and the one or more second cell measurements in accordance with a scaling factor.

In a seventeenth aspect, alone or in combination with one or more of the first through sixteenth aspects, the one or more first cell measurements and the one or more second cell measurements are serving cell measurements for radio resource management.

In an eighteenth aspect, alone or in combination with one or more of the first through seventeenth aspects, the one or more first cell measurements and the one or more second cell measurements are intra-frequency cell reselection measurements.

In a nineteenth aspect, alone or in combination with one or more of the first through eighteenth aspects, the one or more first cell measurements and the one or more second cell measurements are inter-frequency cell reselection measurements.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

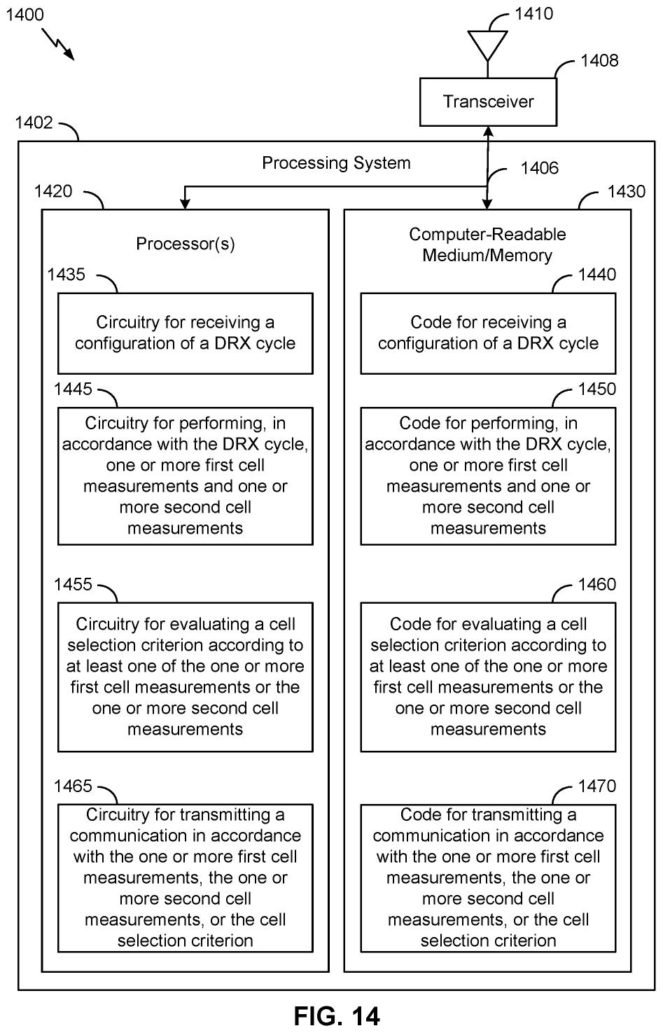

FIG. 14 is a diagram illustrating an example of an implementation of code and circuitry for an apparatus 1400, in accordance with the present disclosure. The apparatus 1400 may be a UE (e.g., UE 120), or a UE may include the apparatus 1400.

The apparatus 1400 includes a processing system 1402 coupled to a transceiver 1408 (e.g., a transmitter and/or a receiver, and which may include a single transceivers or multiple transceivers which may perform different operations described as being performed by the transceiver 408). The transceiver 1408 may be configured to transmit and receive signals for the apparatus 1400 via an antenna 1410, such as the various signals as described herein. The processing system 1402 may be configured to perform processing functions for the apparatus 1400, including processing signals received and/or to be transmitted by the apparatus 1400.

The processing system 1402 includes one or more processors 1420. In various aspects, the one or more processors 1420 may include one or more of receive processor 258, transmit processor 264, Tx MIMO processor 266, and/or controller/processor 280, as described with respect to FIG. 2. The one or more processors 1420 are coupled to a computer-readable medium/memory 1430 via a bus 1406. In various aspects, the computer-readable medium/memory 1430 may include one or more memories such as memory 282, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the process 1300 described with respect to FIG. 13, or any aspect related to it. Note that reference to a processor performing a function of apparatus 1400 may include one or more processors performing that function of apparatus 1400. Note also that reference to one or more processors performing multiple functions may include a first processor performing a first function of the multiple functions and a second processor performing a second function of the multiple functions.

As shown in FIG. 14, the apparatus 1400 may include circuitry for receiving a configuration of a DRX cycle (circuitry 1435).

As shown in FIG. 14, the apparatus 1400 may include, stored in computer-readable medium/memory 1430, code for receiving a configuration of a DRX cycle (code 1440).

As shown in FIG. 14, the apparatus 1400 may include circuitry for performing, in accordance with the DRX cycle, one or more first cell measurements using a main radio of the UE and one or more second cell measurements using a LP-WUR of the UE, wherein a quantity of the one or more first cell measurements and a quantity of the one or more second cell measurements are in accordance with a parameter (circuitry 1445).

As shown in FIG. 14, the apparatus 1400 may include, stored in computer-readable medium/memory 1430, code for performing, in accordance with the DRX cycle, one or more first cell measurements using a main radio of the UE and one or more second cell measurements using a LP-WUR of the UE, wherein a quantity of the one or more first cell measurements and a quantity of the one or more second cell measurements are in accordance with a parameter (code 1450).

As shown in FIG. 14, the apparatus 1400 may include circuitry for evaluating a cell selection criterion according to at least one of the one or more first cell measurements or the one or more second cell measurements (circuitry 1455).

As shown in FIG. 14, the apparatus 1400 may include, stored in computer-readable medium/memory 1430, code for evaluating a cell selection criterion according to at least one of the one or more first cell measurements or the one or more second cell measurements (code 1460).

As shown in FIG. 14, the apparatus 1400 may include circuitry for transmitting a communication in accordance with the one or more first cell measurements, the one or more second cell measurements, or the cell selection criterion (circuitry 1465).

As shown in FIG. 14, the apparatus 1400 may include, stored in computer-readable medium/memory 1430, code for transmitting a communication in accordance with the one or more first cell measurements, the one or more second cell measurements, or the cell selection criterion (code 1470).

Various components of the apparatus 1400 may provide means for performing the process 1300 described with respect to FIG. 13, or any aspect related to it. For example, means for transmitting, sending, or outputting for transmission may include the transceiver(s) and/or antenna(s) 252 of the UE 120 and/or transceiver 1408 and antenna 1410 of the apparatus 1400 in FIG. 14. Means for receiving or obtaining may include the transceiver(s) and/or antenna(s) 252 of the UE 120 and/or transceiver 1408 and antenna 1410 of the apparatus 1400 in FIG. 14.

FIG. 14 is provided as an example. Other examples may differ from what is described in connection with FIG. 14.

The following provides an overview of some Aspects of the present disclosure:

Aspect 1: A method of wireless communication performed by a user equipment (UE), comprising: receiving a configuration of a discontinuous reception (DRX) cycle; performing, in accordance with the DRX cycle, one or more first cell measurements using a main radio of the UE; performing, in accordance with the DRX cycle, one or more second cell measurements using a low-power wakeup radio (LP-WUR) of the UE, wherein a quantity of the one or more first cell measurements and a quantity of the one or more second cell measurements are in accordance with a parameter; evaluating a cell selection criterion according to at least one of the one or more first cell measurements or the one or more second cell measurements; and transmitting a communication in accordance with the one or more first cell measurements, the one or more second cell measurements, or the cell selection criterion.

Aspect 2: The method of Aspect 1, wherein the one or more first cell measurements and the one or more second cell measurements are serving cell measurements.

Aspect 3: The method of any of Aspects 1-2, wherein the one or more first cell measurements use a synchronization signal block and the one or more second cell measurements use a low-power synchronization signal.

Aspect 4: The method of any of Aspects 1-3, wherein the parameter indicates a distribution of the one or more first cell measurements and the one or more second cell measurements.

Aspect 5: The method of Aspect 4, wherein the parameter indicates an integer R, wherein performing the one or more first cell measurements and performing the one or more second cell measurements comprise: performing a first cell measurement of the one or more first cell measurements in every Rth iteration of the DRX cycle; and performing the one or more second cell measurements in remaining iterations of the DRX cycle other than every Rth iteration.

Aspect 6: The method of Aspect 4, wherein the parameter indicates a duration, wherein performing the one or more first cell measurements and performing the one or more second cell measurements comprise performing a single first cell measurement, and the one or more second cell measurements, during the duration

Aspect 7: The method of Aspect 6, further comprising triggering a start of the duration.

Aspect 8: The method of any of Aspects 1-7, further comprising: receiving signaling that indicates a set of values for the parameter; and selecting a value from the set of values, wherein performing the one or more first cell measurements and performing the one or more second cell measurements is in accordance with the value of the parameter.

Aspect 9: The method of Aspect 8, wherein selecting the value comprises selecting the value using at least one of: a length of the DRX cycle, a frequency range of a serving cell of the UE, a frequency band of the serving cell, a frequency gap between a synchronization signal block of the one or more first cell measurements and a low power synchronization signal of the one or more second cell measurements, a transmission periodicity of the low power synchronization signal, a bandwidth of the low power synchronization signal, a class of the UE, a capability of the UE, or the cell selection criterion.

Aspect 10: The method of any of Aspects 1-9, wherein evaluating the cell selection criterion comprises evaluating the cell selection criterion while the main radio is in a sleep state.

Aspect 11: The method of Aspect 10, further comprising triggering the main radio to wake up in association with evaluating the cell selection criterion.

Aspect 12: The method of any of Aspects 1-11, wherein evaluating the cell selection criterion comprises evaluating, by the main radio, the cell selection criterion using the one or more second cell measurements.

Aspect 13: The method of Aspect 12, further comprising storing the one or more second cell measurements, prior to evaluating the cell selection criterion, while the main radio is in a sleep state.

Aspect 14: The method of Aspect 13, further comprising triggering the main radio to wake up in accordance with the one or more second cell measurements failing to satisfy a threshold.

Aspect 15: The method of any of Aspects 1-14, further comprising adjusting a value of the parameter in accordance with a criterion being satisfied.

Aspect 16: The method of Aspect 15, wherein the criterion is associated with at least one of: a measurement threshold, a measurement change threshold, or a combination thereof.

Aspect 17: The method of any of Aspects 1-16, wherein performing the one or more first cell measurements and performing the one or more second cell measurements comprises performing, in association with the UE satisfying a relaxation criterion, the one or more first cell measurements and the one or more second cell measurements in accordance with a scaling factor.

Aspect 18: The method of any of Aspects 1-17, wherein the one or more first cell measurements and the one or more second cell measurements are serving cell measurements for radio resource management.

Aspect 19: The method of any of Aspects 1-18, wherein the one or more first cell measurements and the one or more second cell measurements are intra-frequency cell reselection measurements.

Aspect 20: The method of any of Aspects 1-19, wherein the one or more first cell measurements and the one or more second cell measurements are inter-frequency cell reselection measurements.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
one or more memories comprising processor-executable instructions; and
one or more processors configured to execute the processor-executable instructions and cause the apparatus to:
receive a configuration of a discontinuous reception (DRX) cycle;
perform, in accordance with the DRX cycle, one or more first cell measurements using a main radio of the apparatus;
perform, in accordance with the DRX cycle, one or more second cell measurements using a low-power wakeup radio (LP-WUR) of the apparatus,
wherein a quantity of the one or more first cell measurements and a quantity of the one or more second cell measurements are in accordance with a parameter;
evaluate a cell selection criterion according to at least one of:
the one or more first cell measurements, or
the one or more second cell measurements; and
transmit a communication in accordance with the one or more first cell measurements, the one or more second cell measurements, or the cell selection criterion.

2. The apparatus of claim 1, wherein the one or more first cell measurements and the one or more second cell measurements are serving cell measurements.

3. The apparatus of claim 1, wherein the one or more first cell measurements use a synchronization signal block and the one or more second cell measurements use a low-power synchronization signal.

4. The apparatus of claim 1, wherein the parameter indicates a distribution of the one or more first cell measurements and the one or more second cell measurements.

5. The apparatus of claim 4, wherein the parameter indicates an integer R, wherein the one or more processors, to cause the apparatus to perform the one or more first cell measurements and perform the one or more second cell measurements, are configured to cause the apparatus to:
perform a first cell measurement of the one or more first cell measurements in every Rth iteration of the DRX cycle; and
perform the one or more second cell measurements in remaining iterations of the DRX cycle other than every Rth iteration.

6. The apparatus of claim 4, wherein the parameter indicates a duration, wherein the one or more processors, to cause the apparatus to perform the one or more first cell measurements and perform the one or more second cell measurements, are configured to cause the apparatus to perform a single first cell measurement, and the one or more second cell measurements, during the duration.

7. The apparatus of claim 6, wherein the one or more processors are further configured to cause the apparatus to trigger a start of the duration.

8. The apparatus of claim 1, wherein the one or more processors are further configured to cause the apparatus to:
receive signaling that indicates a set of values for the parameter; and
select a value from the set of values, wherein performing the one or more first cell measurements and performing the one or more second cell measurements is in accordance with the value of the parameter.

9. The apparatus of claim 8, wherein the one or more processors, to cause the apparatus to select the value, are configured to cause the apparatus to select the value using at least one of:
a length of the DRX cycle,
a frequency range of a serving cell of the apparatus,
a frequency band of the serving cell,
a frequency gap between a synchronization signal block of the one or more first cell measurements and a low power synchronization signal of the one or more second cell measurements,
a transmission periodicity of the low power synchronization signal,
a bandwidth of the low power synchronization signal,
a class of the apparatus,
a capability of the apparatus, or
the cell selection criterion.

10. The apparatus of claim 1, wherein the one or more processors, to cause the apparatus to evaluate the cell selection criterion, are configured to cause the apparatus to evaluate the cell selection criterion while the main radio is in a sleep state.

11. The apparatus of claim 10, wherein the one or more processors are further configured to cause the apparatus to trigger the main radio to wake up in association with evaluating the cell selection criterion.

12. The apparatus of claim 1, wherein the one or more processors, to cause the apparatus to evaluate the cell selection criterion, are configured to cause the apparatus to evaluate, by the main radio, the cell selection criterion using the one or more second cell measurements.

13. The apparatus of claim 12, wherein the one or more processors are further configured to cause the apparatus to store the one or more second cell measurements, prior to evaluating the cell selection criterion, while the main radio is in a sleep state.

14. The apparatus of claim 13, wherein the one or more processors are further configured to cause the apparatus to trigger the main radio to wake up in accordance with the one or more second cell measurements failing to satisfy a threshold.

15. The apparatus of claim 1, wherein the one or more processors are further configured to cause the apparatus to adjust a value of the parameter in accordance with a criterion being satisfied.

16. The apparatus of claim 15, wherein the criterion is associated with at least one of:
a measurement threshold,
a measurement change threshold, or
a combination thereof.

17. The apparatus of claim 1, wherein the one or more processors, to cause the apparatus to perform the one or more first cell measurements and perform the one or more second cell measurements, are configured to cause the apparatus to perform, in association with the apparatus satisfying a relaxation criterion, the one or more first cell measurements and the one or more second cell measurements in accordance with a scaling factor.

18. The apparatus of claim 1, wherein the one or more first cell measurements and the one or more second cell measurements are serving cell measurements for radio resource management.

19. The apparatus of claim 1, wherein the one or more first cell measurements and the one or more second cell measurements are intra-frequency cell reselection measurements.

20. The apparatus of claim 1, wherein the one or more first cell measurements and the one or more second cell measurements are inter-frequency cell reselection measurements.

21. The apparatus of claim 1, wherein the one or more first cell measurements and the one or more second cell measurements are neighbor cell measurements.

22. A method of wireless communication performed by a user equipment (UE), comprising:
receiving a configuration of a discontinuous reception (DRX) cycle;
performing, in accordance with the DRX cycle, one or more first cell measurements using a main radio of the UE;
performing, in accordance with the DRX cycle, one or more second cell measurements using a low-power wakeup radio (LP-WUR) of the UE,
wherein a quantity of the one or more first cell measurements and a quantity of the one or more second cell measurements are in accordance with a parameter;
evaluating a cell selection criterion according to at least one of:
the one or more first cell measurements, or
the one or more second cell measurements; and
transmitting a communication in accordance with the one or more first cell measurements, the one or more second cell measurements, or the cell selection criterion.

23. A non-transitory computer-readable medium storing a set of instructions for wireless communication, the set of instructions comprising:
one or more instructions that, when executed by one or more processors of a user equipment (UE), cause the UE to:
receive a configuration of a discontinuous reception (DRX) cycle;
perform, in accordance with the DRX cycle, one or more first cell measurements using a main radio of the UE;
perform, in accordance with the DRX cycle, one or more second cell measurements using a low-power wakeup radio (LP-WUR) of the UE,
wherein a quantity of the one or more first cell measurements and a quantity of the one or more second cell measurements are in accordance with a parameter;
evaluate a cell selection criterion according to at least one of:
the one or more first cell measurements, or
the one or more second cell measurements; and
transmit a communication in accordance with the one or more first cell measurements, the one or more second cell measurements, or the cell selection criterion.

24. An apparatus for wireless communication, comprising:
means for receiving a configuration of a discontinuous reception (DRX) cycle;
means for performing, in accordance with the DRX cycle, one or more first cell measurements using a main radio of the UE;
means for performing, in accordance with the DRX cycle, one or more second cell measurements using a low-power wakeup radio (LP-WUR) of the UE,
wherein a quantity of the one or more first cell measurements and a quantity of the one or more second cell measurements are in accordance with a parameter;
means for evaluating a cell selection criterion according to at least one of:
the one or more first cell measurements, or
the one or more second cell measurements; and
means for transmitting a communication in accordance with the one or more first cell measurements, the one or more second cell measurements, or the cell selection criterion.
